(19) United States
(12) Patent Application Publication
(10) Pub. No.: US 2002/0123961 A1
(43) Pub. Date: Sep. 5, 2002

(54) Computerized retail lease program selection systems and methods

(76) Inventors: Atanas Stoyanov, Thousand Oaks, CA (US); Ryan DeLaet, Thousand Oaks, CA (US); Damion Moyer-Sims, Portland, OR (US); Clifford Drew Wells, Westlake Village, CA (US); Russell West, Camarillo, CA (US); Russell G. West, Agoura Hills, CA (US); David Bartels, Westlake Village, CA (US)

Correspondence Address: Attn: Marc E. Brown, OPPENHEIMER WOLFF & DONNELLY LLP, Suite 3800, 2029 Century Park East, Los Angeles, CA, 90067, US

(21) Appl. No.: 10/057,435

(22) Filed: Jan. 25, 2002

Related U.S. Application Data
(60) Provisional application No. 60/264,646, filed on Jan. 25, 2001.
(60) Provisional application No. 60/264,595, filed on Jan. 25, 2001.

(51) Int. Cl. G06F 17/60

(52) U.S. Cl. 705/38; 705/35

(57) ABSTRACT

Systems and methods for enabling automobile dealers select a lease for a prospective customer are disclosed. The selection is made from an extensive database of leases comprising lease packages from a plurality of financial institutions and other sources. The selection is determined according to a series of complex calculations designed to meet customer criteria, maximize dealer profit, and minimize waiting-time.

### RELATED APPLICATIONS

This Application claims priority of U.S. Provisional Application No. 60/264,646 filed Jan. 25, 2001, incorporated herein by reference.

### BACKGROUND OF THE INVENTION

1. Field of the Invention

This invention relates to consumer lease qualification and selection systems and methods. More particularly, the invention relates to computerized systems and methods identifying lease packages available to a customer based on his or her individual qualifications coupled with a seller's profit objectives.

2. General Background and State of the Art

Automobile sales and leasing have made significant progress in the marketplace in recent years. A booming economy has provided consumer confidence and, in turn, increased sales in the automotive industry. Recent advances in technology, including the instantaneous nature of the “virtual world” experienced over the Internet, is providing additional impetus for a move toward further modernization of the automobile sales industry. As society becomes increasingly accustomed to immediate service and instant results, as is now commonly provided by on-line retailers in many consumer markets, there is a need in the auto sales industry to develop new methods for providing service that is also immediate and satisfactory to its customers.

Customers appreciate the added service that is offered by automobile dealers who are able to provide lease packages to their customers. The added offering is beneficial to the dealers as well, as profit can be made not only on the sale of the automobile, but on the sale of the lease package as well. Unfortunately, these additional offerings of lease programs by automobile dealers are significantly limited in several ways.

Often, dealers are unable to offer a large variety of lease sources, such as through banks, credit unions, or other independent financial institutions. The infrastructure required for an automobile dealer to offer such options would be extremely burdensome, as it would require careful tracking and organization of innumerable criteria and data related to such financing programs. As a result, many automobile dealers offer leases funded by the automobile company itself.

Those automobile dealers who are able to offer alternate lease programs, generally may only offer a limited fraction of all that is truly available. Auto dealers do not currently have the means by which to access every lease program from every financial institution. Rather, any single automobile dealer only knows of and has access to a limited number of financial institutions' lease programs.

Even those automobile dealers who are able to access a limited number of financial institutions' lease programs face a significant obstacle of timeliness. Generally, when accessing an outside financial institution for a lease program, the automobile dealer acts as a “middle man” between the customer and the financial institution, passing information back and forth between the two parties. This exchange of information, as well as the reliance on the financial institution to consider the customer's information and approve or deny the customer for financing, requires a certain amount of processing time. The processing time translates into waiting time from the customer's perspective. The more time that is required, the more likely the customer is to become impatient and seek his own financing elsewhere.

The time constraint explained above also impacts the effectiveness of the dealer's lease program sales by making it difficult, or impossible, for a dealer to identify the “best” lease program for his customer in the limited amount of time available for calculating and searching for a lease program. A significant number of variables enters into calculations involving lease programs. These variables include some attributable to the lease program itself, and some attributable to a customer. Because customer-related variables, such as the amount of cash a customer has available to use on a down payment or the amount of money the customer can afford to spend on a monthly payment, cannot be determined until the time the customer engages in negotiations with the dealer, these complicated lease program calculations cannot be performed ahead of time. The dealer must perform the calculations while the customer is waiting. Because of the large number of variables and the limited amount of time, dealers may be unable to optimize the variables and identify the best lease program for the customer.

In addition to time constraints, current calculation methods available to auto dealers may limit the dealers' ability to optimize lease program selection. For example, existing lease program comparison methods typically require dealers to use a fixed down payment amount as a basis for comparison between lenders and their lease programs. However, down payments are only one portion of the up-front fees required from a customer at the inception of a lease program. Other fees will include, for example, finance inception fees, taxes, and registration and license fees. These additional fees typically affect the suitability of a particular lease program to a particular customer, yet dealers are currently unable to consider the effects of these fees when selecting a lease program for the customer. Generally, only after a lease program has been selected, are the additional inception fees considered. At that point, should the inception fees cause the selected lease program to be too burdensome for the customer, the dealer must select another lease program. This process is inefficient and time consuming. Moreover, it fails to allow dealers to consider certain important data when selecting lease programs for their customers.

In addition to not allowing dealers to consider important variables, such as various inception fees, when comparing lease programs for the purpose of selecting the best lease program for a customer, prior art methods typically do not allow dealers to compare lease programs according to paid reserve. This is a significant drawback for a dealer when selecting a lease program most beneficial to the dealer, because paid reserve amounts are a substantial portion of any financial gain a dealer will receive in the execution of a deal. Currently, however, dealers compare lease programs on the basis of single components of a paid reserve, rather than on the entire paid reserve amount. Therefore, dealers may not always have the ability to select the most profitable lease program.

What is needed is a way for automobile dealers to offer their customers (1) a wide array of financing options that benefit both the customer's budget requirements and the dealers profit goals (2) in a relatively short time period designed to minimize a customer's waiting time (3) while considering a plurality of data that bear on the applicability of financing options to the customer. Such a system would provide customers with viable lease options immediately and without delay, and would provide the automobile dealer both the added profit gained by selling leases as well as indications of the which leases will provide the highest profit.

### INVENTION SUMMARY

The present invention includes a computerized system that helps auto dealers select a lease for a prospective customer that meets the criteria of the customer (e.g. a monthly payment), while maximizing the profit which the dealer makes in the transaction. The leases available to the auto dealer comprise an extensive database that is far-reaching and continually updated. The complex calculations are designed to locate leases that will generate the most substantial profit for the auto dealer. This combination of calculations maximizes efficiency and reduce the customer's waiting time by providing prompt results.

The large number of criteria that go into calculating the customer's costs and dealer profits in connection with each lease program, coupled with the large number of lease and lease programs that are available, makes it very difficult, as a practical matter, for a dealer to select the lease program that represents the best deal for the customer and/or provides the most profit for the dealer. As a consequence, a lease is often selected that is less than optimal.

The invention includes a computerized system that methodically examines an entire database of lease programs and selects the ones that are optimal for the customer and/or the dealer. The invention encompasses multiple related methods for identifying and selecting optimal lease programs.

The invention is directed, in part, to the concept of a computerized system that considers upward adjustments in the sales price of the vehicle as a means for locating the optimal lease when the inception fees which a buyer must pay (e.g., the first payment, security deposit, bank fees, registration fees, documentation fees) cannot exceed a certain amount. The monthly payment a buyer must make for a lease is dependent upon the amount of customer cash paid at inception. In many cases, however, a buyer cannot afford to pay more than a certain portion of the inception fees. This, in turn, can lead to a high monthly payment. In some cases, however, a lower monthly payment can be realized by increasing the interest rate of the lease (according to the lender's policies) and waiving a portion of the inception fees. This new feature of the invention implements this concept in an automated fashion to better locate the optimal lease. While systems and methods of the prior art compare only down payment amounts between lease programs, and require varying amounts of customer cash between different lenders and their lease programs, the systems and methods of the present invention enable a dealer to compare lenders and their lease programs based on available customer cash.

A second feature of the invention includes for the computer system to search through the inventory of vehicles that are on a dealer's lot to find the ones that meet various lease or customer criteria. This feature is actually far more complicated than might be imagined at first. Part of the reason is because the terms which a lessor provides often vary as a function of the particular vehicle. A dealer may enter a desired profit and search for vehicles and associated lease programs having the lowest monthly payment. Conversely, a dealer may enter a desired monthly payment and search for vehicles and associated lease programs having the highest profit.

A third feature of the invention involves the computer system allowing the dealer to search for leases that meet a specified “paid reserve” amount. As is well known in the auto industry, “paid reserve” is money which the or lessor pays back to the dealer as a type of commission. Sometimes, the “paid reserve” is a fixed percentage of the vehicle price. Other times, it depends upon the “money factor” for leases, which the dealer can procure from the customer. Thus, if the dealer can procure a higher money factor, the dealer will receive a higher “paid reserve.” This feature not only identifies lease programs that will yield a specified paid reserve, but also calculates for the dealer what money factor must be applied to each of the programs in order to yield that paid reserve. This enables a dealer to select a lease program the represents the best deal for the customer, while providing the dealer with a specified paid reserve.

A fourth feature of the invention, applicable only to lease systems, is that the dealer can fix the selling price for a vehicle and the computer will identify lessors who can offer lease programs yielding the highest profits. Sometimes, a buyer will tell the dealer that the buyer is only willing to pay a certain price over the factory invoice. This feature of the invention allows the dealer to meet this limitation, without sacrificing the needed amount of profit. The dealer instructs the computer to find all leases for the vehicle at the price specified by the customer, while maximizing other factors such as the paid reserve and the warranty price to maximize the dealer's profit.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. 1 is a flow diagram illustrating steps of a first, profit search embodiment of the present invention.

FIG. 2 is a flow diagram illustrating steps of a second, payment search embodiment of the present invention which.

FIG. 3 is a flow diagram illustrating steps of a third, maximized search embodiment of the present invention.

FIG. 4 is a flow diagram illustrating steps of a fourth, paid reserve calculation embodiment of the present invention.

FIG. 5 is a flow diagram illustrating steps of a fifth, fixed paid reserve scan embodiment of the present invention.

FIG. 6 is a flow diagram illustrating steps of a sixth, rate adjustment calculation embodiment of the present invention.

FIG. 7 is a flow diagram illustrating steps of a seventh, application builder embodiment of the present invention.

FIG. 8 illustrates an exemplary computer system on which various embodiments of the present invention may be practiced.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized and structural and functional changes may be made without departing from the scope of the present invention.

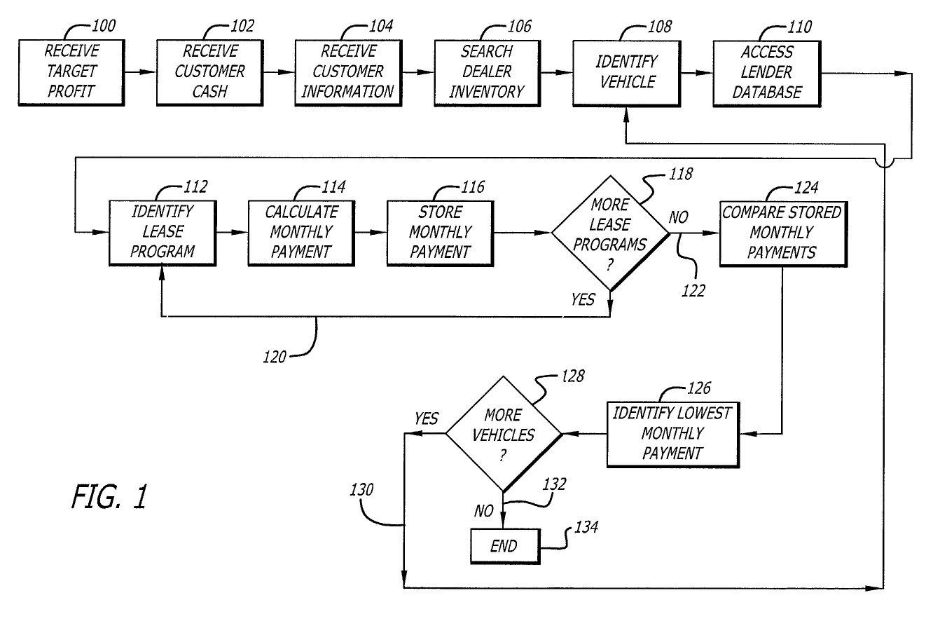

FIG. 1 is a flow diagram illustrating steps of a first, profit search embodiment of the present invention. This first embodiment involves a method in which, from a plurality of lease programs, the lease program requiring the lowest monthly payment for a fixed amount of customer cash is identified for each of a plurality of vehicles. More specifically, a dealer specifies a target profit he hopes to achieve in a deal, the amount of cash his customer has available to initiate the deal and other customer information. Using this information, the method of the present invention identifies, from among a plurality of available lease programs, the lease program requiring the lowest monthly payment of the customer.

As used herein, “customer cash” refers to the amount of money a customer offers for up-front payment at the inception of a lease program. Customer cash is typically applied to down payment, bank fees, registration fees, security deposit, documentation fees, and other inception fees. Also, as used herein, “customer information” refers to a customer's financial and personal data. This data may include information specific to a customer's financial history and used by credit bureaus to generate credit ratings. A customer's financial data, when utilized by embodiments of the present invention, typically are indicative of the likelihood of that customer being approved for a lease program.

Turning now to the specific steps performed in this first embodiment, and as indicated at block 100, the dealer enters, into a computer program, the target profit. The dealer also enters the amount of customer cash, shown at block 102, and other customer information, shown at block 104. As in all embodiments described herein, the entry of data may be performed with a keyboard or other peripheral device, and may be facilitated by a graphical user interface with fields presented to the dealer for receiving the information. Of course, other data entry methods are anticipated as being within the scope of the invention. Such methods include, but are not limited to, a magnetic media decoder that could, for example, be used to read information from a customer's drivers license, wireless transmission means to transmit data from a remote collection site to a main computer system, or a combination of both.

After the requisite information has been entered by the dealer and received by the system, the method of the first embodiment proceeds to search the dealer inventory of vehicles, as shown at block 106. Because the method identifies a lease program for each vehicle in the dealer's inventory, each vehicle is identified in turn, as shown at block 108. A lender database is then accessed, as shown at block 110. The lender database may include a plurality of lease programs available to the dealer. The method therefore analyzes each lease program in turn, starting with the first lease program it identifies, as indicated at block 112. For the identified lease program, the software method of the first embodiment calculates a monthly payment as shown at block 114, given the amount of customer cash, other customer information, and requisite target profit that must be generated by the lease program for the dealer. The calculated monthly payment is stored, as shown at block 116, such as in a temporary file. The software then determines whether there are more lease programs to be evaluated, as indicated at block 118. If so, then as indicated by arrow 120, the next lease program is identified and the previously described process repeats. The process repeats until the answer determined at block 118 is negative, as indicated at arrow 122.

After all lease programs have been evaluated for the identified vehicle, the software compares the monthly payments it has stored, as indicated at block 124, and identifies the lease program that requires the lowest monthly payment at block 126. At block 128, the method determines whether there are additional vehicles in the dealer's inventory for which lease programs are to be evaluated. If so, then as indicated at arrow 130, the lease program evaluation routine previously described is performed for the next identified vehicle. In this manner, the lease program which requires the lowest monthly payment, given the entered customer cash and customer information, while generating the dealer's target profit, is identified for each car in the dealer's inventory. After the system identifies these lease programs for each car in the dealer's inventory, it determines that there are no more vehicles in the dealer's inventory, as indicated at arrow 132, and the process ends, as indicated at block 134.

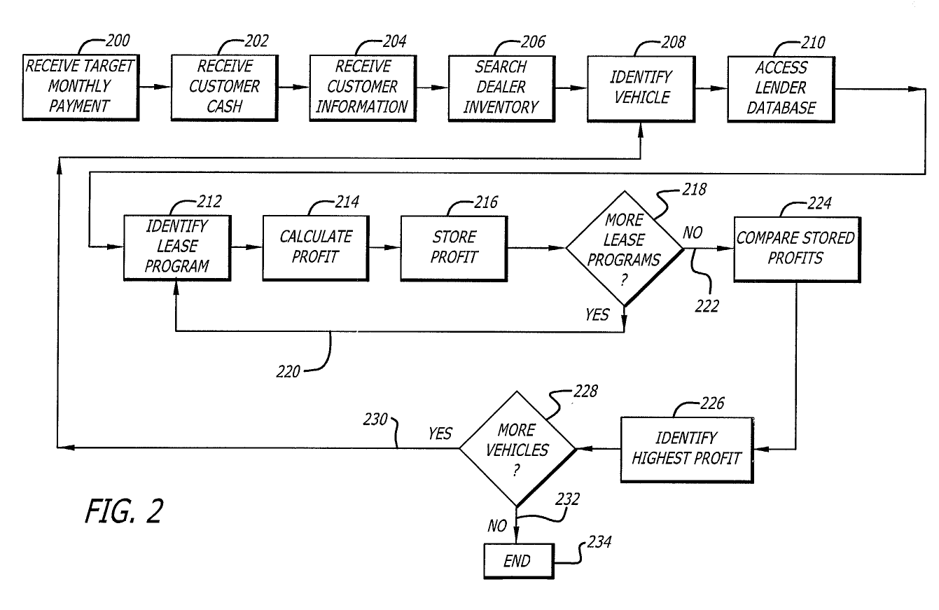

FIG. 2 is a flow diagram illustrating steps of a second, payment search embodiment of the present invention. This second embodiment involves a method in which, from a plurality of lease programs, the lease program yielding the highest dealer profit for a target monthly payment is identified for each of a plurality of vehicles. More specifically, the dealer enters a target monthly payment, such as the maximum monthly payment the customer is willing or able to make, and the method of the second embodiment identifies, from among a plurality of available lease programs, the lease program which generates the highest profit for the dealer.

In this second embodiment, the dealer enters a target monthly payment, the amount of available customer cash, and other customer information, as indicated at blocks 200, 202 and 204, respectively. The method then searches the dealer inventory of vehicles, as indicated at block 206. Within the searched inventory, a first vehicle is identified at block 208, and a lender database is accessed at block 210. From the available lease programs listed within the lender database, a first lease program is identified at block 212. At block 214, the software calculates the profit that will be generated by the identified lease program given the amount of available customer cash and required target monthly payment. The profit calculation includes maximizing the amount of profit that can be generated by the identified lease program under the constraints described above. Maximizing the profit may include, for example, increasing the vehicle sale price or making upward adjustments in the sale price of other profit sources, such as warranty. The calculated profit is stored at block 216, such as in a temporary file. At block 218 the program considers whether additional lease programs are available within the lender database. If so, then as indicated at arrow 220 the profit calculation routine is repeated for each available lease program, until the answer at block 218 is negative, as indicated at arrow 222.

After the profit is calculated for each available lease program for the identified vehicle, the stored profits are compared, at block 224, and the lease program which generates the highest profit is identified at block 226. At block 228, the software considers whether the dealer inventory includes more vehicles. If yes, as indicated by arrow 230, the lease program evaluation is repeated for the next identified vehicle, until the most profitable lease program is identified for every vehicle in the dealer's inventory. When there are no more vehicles to repeat the lease program evaluation routine for, as indicated at arrow 232, the process ends, as indicated at block 234.

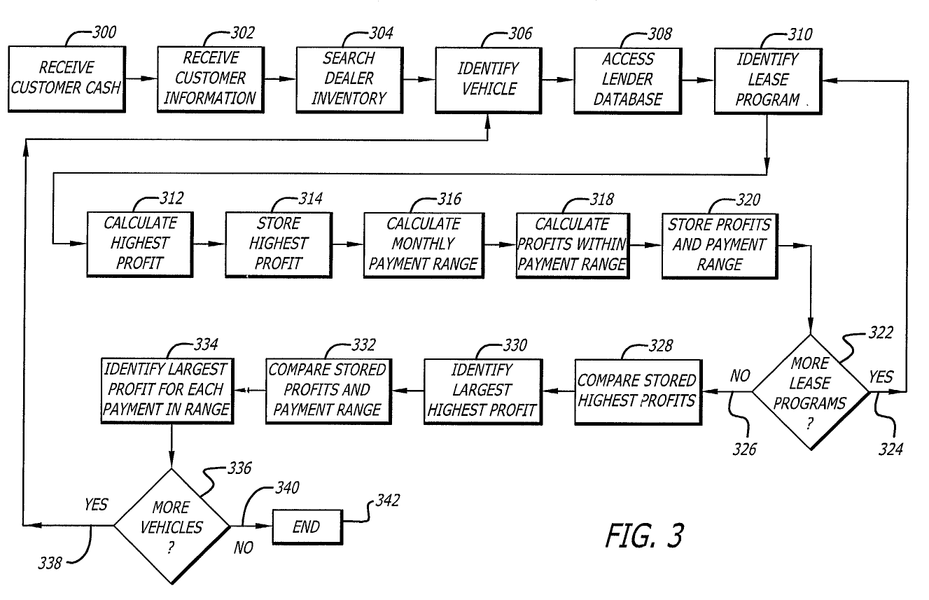

FIG. 3 is a flow diagram illustrating steps of a third, maximized search embodiment of the present invention. The third embodiment involves a method in which, from a plurality of lease programs, the lease program yielding the highest profit for a fixed amount of customer cash is identified for each of a plurality of vehicles and, with respect to each of the vehicles, for a plurality of various monthly payments. This embodiment allows a dealer to optimize several criteria in a single search. More specifically, a dealer enters only a fixed amount of customer cash, and the method of the invention identifies lease programs that optimize both the profit and the monthly payment.

Turning to the specific steps in the exemplary third embodiment, the dealer enters the amount of available customer cash, as indicated at block 300. The dealer also enters other customer information, at block 302. Upon receipt of this information, the software searches the dealer inventory, at block 304, and identifies a first vehicle, at block 306. The software then accesses, for that vehicle, a lender database that stores information about a plurality of lease programs, as indicated at block 308.

A first lease program is identified, at block 310, for which a profit and range of monthly payments will then be evaluated. First, at block 312, the highest possible profit capable of being produced by the identified lease program for the amount of available customer cash is calculated. This calculation involves solving for variables such that the profit generated by the lease program is maximized. While it may seem that the software would simply need to increase the sale price of the vehicle, warranty, and other such amounts in order to maximize the profit, and do so indefinitely, the profit maximizing calculations are actually bounded by limits of several of the variables. For example, each lender typically limits the amount of sale price it will finance. An example would be a lender who will finance a sale price of not more than 110% of the vehicles Manufacturer Suggested Retail Price (MSRP). Therefore, the software would be limited in any upward adjustment to the vehicle sale price by an upper bound of 110% of the vehicle's MSRP. Similarly, a lender may limit the interest rate spread it will allow. For example, a lender who limits an interest rate spread to 2% causes this limit to be imposed upon the software when it is attempting to maximize the amount of profit the lease program can generate. The profit maximizing calculations also include maximizing the profit on individual dealer options that are not included in the sale price of the vehicle. These options may include, for example, vehicle options and warranties.

For purposes of clarity, the term “rate spread” as used herein denotes the difference between a lender's rate (buy rate) and a dealer's rate after markup (sell rate). In lease programs, these rates are “money factors,” and the rate spread generates additional profit which may be allocated entirely to the dealer or split between the lender and the dealer.

After it is calculated, the highest profit is stored, at block 314, such as in a temporary file. Next, at block 316, a range of possible monthly payments is identified for the identified lease program, and selected monthly payment amounts are identified within the monthly payment range. At block 318, the profit which would be generated by the identified lease program for each of the monthly payment amounts identified at block 316 is calculated. These monthly payments and associated profits are then stored, at block 320.

After calculating the highest possible profit and the various profits generated for identified monthly payments for the identified lease program, the software considers at block 322 whether additional lease programs are within the lender database. If yes, as indicated at arrow 324, the profit calculation process repeats. In this manner, the profit potential for every available lease program is calculated, until the question at block 322 results in a negative answer. When the process has been performed for each available lease program, and there are no more lease programs to consider, as indicated at arrow 326, the software compares the stored highest profits, at block 328 and identifies which lease program generated the largest of the stored highest profits, at block 330. The software also compares the profits associated with the identified monthly payments, at block 332, and identifies for the dealer at block 334 which lease program generated the largest profit for each of the identified monthly payments. This information allows the dealer to present a wealth of valuable information to the customer, which can then be used by the customer or the dealer to select the best lease program.

Of course, the entire process may be repeated for each vehicle in the dealer's inventory. At block 336 the software determines whether additional vehicles are in the dealer's inventory. If so, as indicated by arrow 338, the process repeats for those vehicles. Eventually, when there are no more vehicles to evaluate, as indicated at arrow 340, the process ends, at block 342.

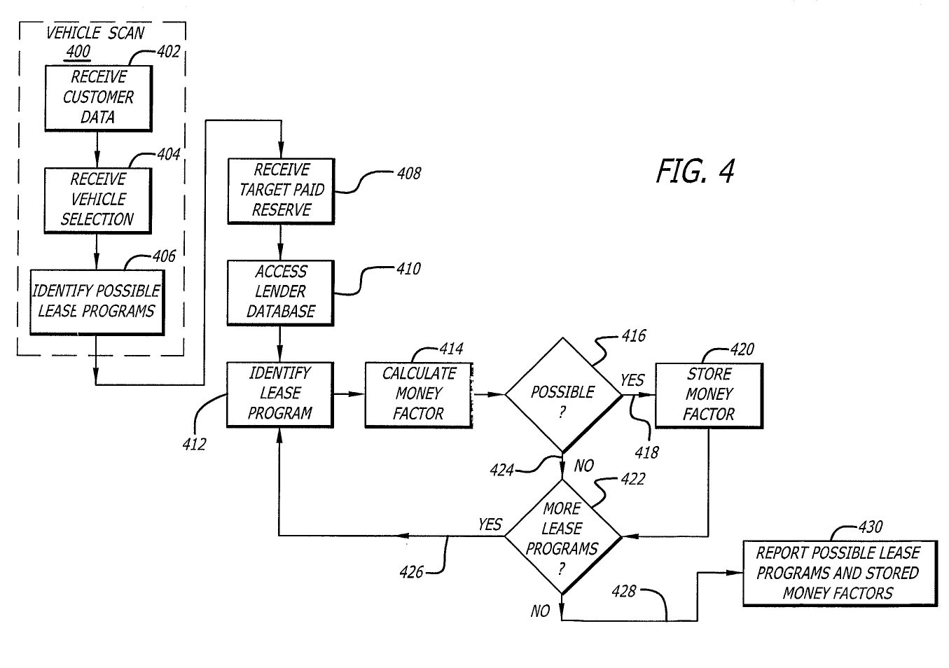

FIG. 4 is a flow diagram illustrating steps of a fourth, paid reserve calculation embodiment of the present invention. The fourth embodiment involves a method which, from a plurality of lease programs, identifies all lease programs capable of yielding a target paid reserve amount and, for each identified lease program, advises what money factor must be used to yield the target paid reserve amount. Specifically, after running a vehicle scan, which will be explained in further detail below, a dealer determines and enters the amount of paid reserve he wants to make on the deal. This amount is the target paid reserve. The method of this fourth exemplary embodiment of the invention then accesses the lender database and identifies, for the dealer, which lease programs available therein are capable of generating the target paid reserve.

The term “paid reserve” as used herein refers to an amount of money paid by a lender to a dealer in exchange for the dealer selecting one of the lender's lease programs when making a deal with a customer. Calculating paid reserve amounts involves rate spread and rate participation.

The term “rate spread” as used herein refers to a money factor increase applied by a dealer to a lease program offered by a lender. A rate spread, then, causes a customer to pay a higher amount of money over the term of the lease. The term “rate participation” as used herein is a percentage of the rate spread in which the dealer can participate. For example, a lender having a fifty percent participation rate would offer dealers a paid reserve amount equal to fifty percent of the difference in a customer's payments caused by the rate spread.

Returning to a description of paid reserve, these amounts typically calculated as a percentage of the anticipated difference in payments over the entire lease period caused by a rate spread. For example, if a lease term is 36 months, and the rate spread causes the customer's monthly payment to increase by $20 per month, the paid reserve will be the rate participation percentage multiplied by $20 multiplied by 36. Alternatively, paid reserve can be calculated as a percentage of the capitalized cost of a vehicle. Either way, the paid reserve amount is generally paid to the dealer at the time of asale.

Finally, before returning to a discussion of the fourth method embodiment of the present invention, the specification will proceed with a description of a vehicle scan. A scan is a query and set of calculations conducted by the system for a single type of vehicle. Some of the steps included in a vehicle scan are identified in FIG. 4, at block 400. First a dealer enters customer data, which is received by a system performing the scan, at block 402. Next the dealer identifies which vehicle his customer is interested in, and this vehicle selection is received at block 404. The scan is then completed when lease programs that are possibilities for the selected vehicle and the customer data are identified and reported to the dealer, at block 406.

Continuing with FIG. 4 and returning to the description of the fourth, paid reserve calculation, embodiment of the present invention, vehicle scan 400 is followed by the dealer entering the target paid reserve, at block 408. The lender database is then accessed at block 410, and lease programs are identified therein as being available to the dealer and his customer. For each lease program identified, a paid reserve amount is calculated.

At block 412, the first of the available lease programs is identified. Then the method attempts to calculate a minimum money factor that must be used with the identified lease program in order to generate the target paid reserve, at block 414. According to the result of this calculation, the method determines whether the identified lease program is able to generate the target paid reserve, at block 416, with a money factor not more than a maximum money factor amount, determined by either the lender or the dealer. If a minimum money factor was calculated, and the identified lease program is capable of generating the target paid reserve with that money factor, as indicated by arrow 418, then the calculated money factor is stored, such as in a temporary file, at block 420. Next, whether the identified lease program was capable of generating the target paid reserve, as indicated by arrow 418, or not, as indicated by arrow 424, the method determines, at block 422, whether there are more available lease programs in the lender database. If more lease programs are available, as indicated at arrow 426, the money factor calculation described above continues until the answer generated at block 422 is no, as indicated by arrow 428.

Once the money factor calculation has been performed for all available lease programs in the lender database, then at block 430 the method identifies, for the dealer, which lease programs were capable of generating the target reserve and reports the stored money factors that must be used for each of the capable lease programs.

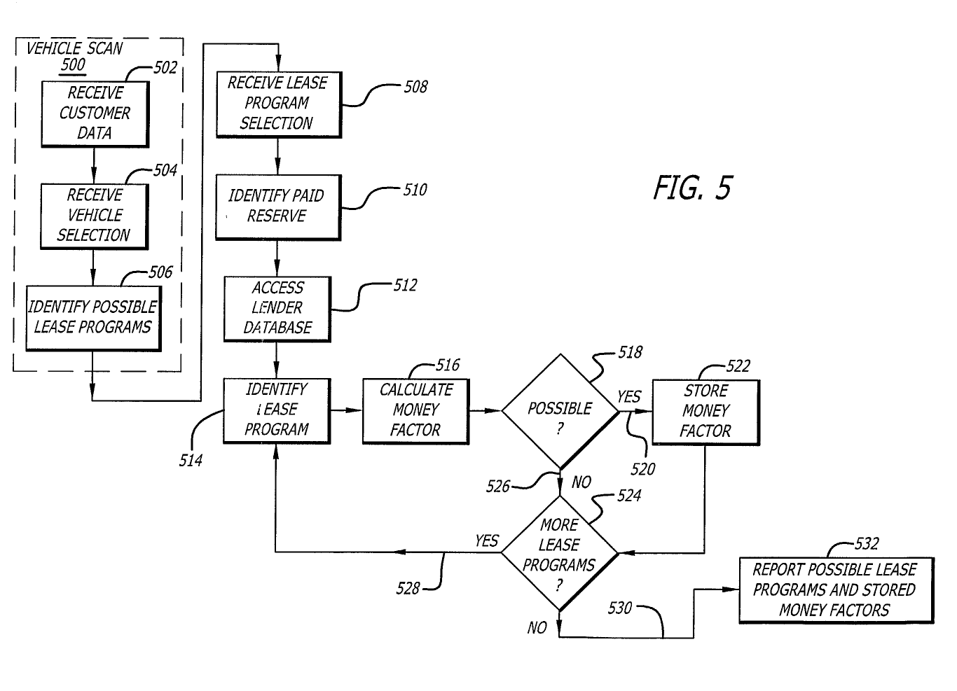

FIG. 5 is a flow diagram illustrating steps of a fifth, fixed paid reserve scan embodiment of the present invention. The fifth embodiment involves a method in which paid reserve amounts generated by each of a plurality of lease programs are calculated, and all lease programs capable of generating one of the calculated paid reserve amounts, selected by a user, are identified. Specifically, after performing a vehicle scan, a dealer selects one of the identified possible lease programs having the most favorable paid reserve amount, and the method of this fifth embodiment identifies which of the unselected possible lease programs are also capable of producing that paid reserve.

Vehicle scan 500 includes receiving customer data entered by a dealer at block 502, receiving vehicle selection entered by the dealer at block 504 according to his customer's interest, and identifying, at block 506, which lease programs are possible to offer the customer according to the vehicle selection and the customer data. After vehicle scan 500 returns a list of possible lease programs, including the amount of paid reserve each will generate, the dealer selects one of them. This selection may be made, for example according to which lease program generates the highest amount of paid reserve. After receiving the dealer's lease program selection, at block 508, the method identifies, at block 510, the maximum amount of paid reserve that can be generated by the selected lease program. The method then includes steps to identify any other available lease programs that are capable of producing the identified paid reserve amount.

First, the method accesses the lender database of available lease programs, at block 512. At block 514, the first of the available lease programs is identified. Then the method attempts to calculate a minimum money factor that must be used with the identified lease program in order to generate the identified paid reserve, at block 516. According to the result of this calculation, the method determines whether the identified lease program is able to generate the identified paid reserve, at block 518, with a money factor not more than a maximum money factor amount, determined by either the lender or the dealer. If a minimum money factor was calculated, and the identified lease program is capable of generating the identified paid reserve with that money factor, as indicated by arrow 520, then the calculated money factor is stored, such as in a temporary file, at block 522. Next, whether the identified lease program was capable of generating the identified paid reserve, as indicated by arrow 520, or not, as indicated by arrow 526, the method determines, at block 524, whether there are more available lease programs in the lender database. If more lease programs are available, as indicated at arrow 528, the money factor calculation described above continues until the answer generated at block 524 is no, as indicated by arrow 530.

Once the money factor calculation has been performed for all available lease programs in the lender database, then at block 532 the method identifies, for the dealer, which lease programs were capable of generating the identified paid reserve and reports the stored money factors that must be used for each of the capable lease programs.

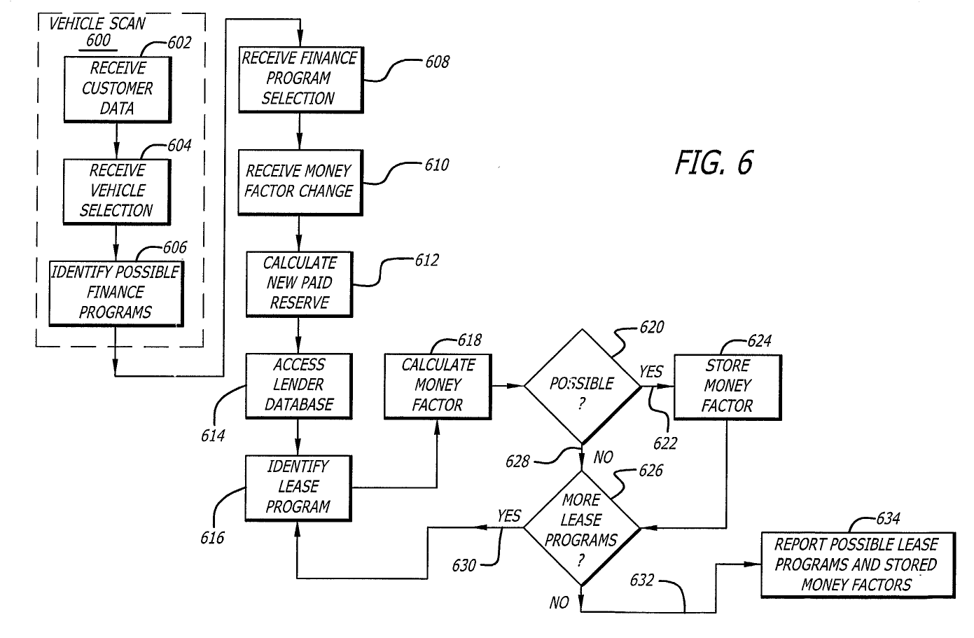

FIG. 6 is a flow diagram illustrating steps of a sixth, rate adjustment calculation embodiment of the present invention. In the method of the sixth embodiment, paid reserve amounts generated by each of a plurality of lease programs are initially calculated. Then the paid reserve amount generated by one of the lease programs is re-calculated according to a change in the money factor effectuated by a user. Finally, money factors required by the rest of the lease programs in order for them to generate the re-calculated paid reserve amount are calculated. Specifically, after a user runs a vehicle scan and receives a list of possible lease programs, he enters a money factor change for one of the lease programs, and the method of this sixth embodiment recalculates a new paid reserve that the lease program will generate with the new money factor. Then, the method includes steps for identifying, from all available lease programs in the lender database, which lease programs are capable of generating the new paid reserve amount.

Vehicle scan 600 includes receiving customer data entered by a dealer at block 602, receiving vehicle selection entered by the dealer at block 604 according to his customer's interest, and identifying, at block 606, which lease programs are possible to offer the customer according to the vehicle selection and the customer data. After vehicle scan 600 returns a list of possible lease programs, including the amount of paid reserve each will generate, the dealer selects one of them at block 608. This selection may be made, for example according to which lease program generates the highest amount of paid reserve, or some other attribute that makes the lease program desirable for either the dealer or the customer.

After receiving the dealer's lease program selection, at block 608, the dealer ascertains the money factor initially established for the selected lease program. This money factor may be a default value established by the lender, or it may be a value that was calculated during vehicle scan 600 in order to “force” the lease program to “fit” the needs of the customer and the dealer. After determining the initial money factor used in the selected lease program, the dealer enters a money factor change, at block 610. This change may be, for example, an increase in the money factor in order to achieve a higher paid reserve amount for the lender. After the money factor change is received from the dealer's entry, at block 610, a new paid reserve amount is calculated for the selected lease program, using the new money factor.

The exemplary method next includes steps for accessing the lender database at 614 and determining whether other available lease programs are capable of also producing the new paid reserve. At block 616, the first of the available lease programs is identified. Then the method attempts to calculate a minimum money factor that must be used with the identified lease program in order to generate the new paid reserve, at block 618. According to the result of this calculation, the method determines whether the identified lease program is able to generate the new paid reserve, at block 620, with a money factor not more than a maximum money factor amount, determined by either the lender or the dealer. If a minimum money factor was calculated, and the identified lease program is capable of generating the new paid reserve with that money factor, as indicated by arrow 622, then the calculated money factor is stored, such as in a temporary file, at block 624. Next, whether the identified lease program was capable of generating the new paid reserve, as indicated by arrow 622, or not, as indicated by arrow 628, the method determines, at block 626, whether there are more available lease programs in the lender database. If more lease programs are available, as indicated at arrow 630, the money factor calculation described above continues until the answer generated at block 626 is no, as indicated by arrow 632.

Once the money factor calculation has been performed for all available lease programs in the lender database, then at block 634 the method identifies, for the dealer, which lease programs were capable of generating the new paid reserve and reports the stored money factors that must be used for each of the capable lease programs.

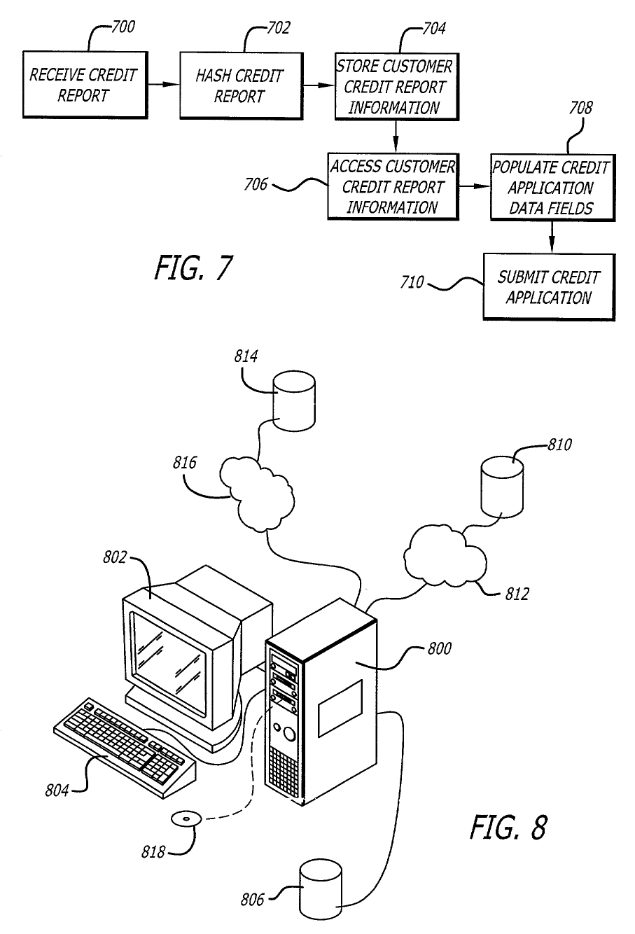

FIG. 7 is a flow diagram illustrating steps of a seventh, application builder embodiment of the present invention in which information from a credit report is hashed and used to populate fields within formal credit applications. At block 700, a credit report is received for a particular customer. The credit report may be one of any number of standard credit reports from a credit reporting agency, or it may be a truncated credit report, known in the industry as a “five line report.” After receipt, the exemplary method “hashes” the credit report, at block 702. Specifically, the method identifies fields of data in the credit report and excerpts data from those fields. Then, at block 704, the method stores the excerpted data, such as in a computer file. The data may be stored for any amount of time, and is useful at a point in time with the customer wishes to apply for a lease from a particular lender. For example, if a dealer identifies lease according to any one of the exemplary methods previously described, his customer would then need to apply with the lender to qualify for that lease. At that time, the dealer accesses the customer's stored credit report information at block 706, and uses the stored information to populate data fields of a credit application at block 708, such as to apply for the lease. After the credit application is complete, it is submitted, at block 710, to the lender.

An exemplary hardware system on which various embodiments of the invention may be practiced is illustrated in FIG. 8. It is anticipated that embodiments of the invention will be practiced on a hardware system comprising a computer 1100 having such peripheral devices as an input keyboard 1104, video screen 1102, and a hard drive for data storage 1106. The invention may be practiced with a database, for storage and retrieval of various financial and vehicle data. The database may be a local database 1108 accessible via a local computer network 110, or it may be a remote database 1112 accessible over the Internet 1114. A computer processor may be utilized to carry out calculations according to the invention. It is also anticipated that the invention may be practiced within a network environment. For example, remote databases may be accessed from a dealer location, such as over a telephone or cable data communications line. Software embodiments of calculations of the present invention may be stored on computer readable media, such as CD-ROM 1116 or other media.

The foregoing description of the preferred embodiments of the invention has been presented for the purposes of illustration and description. It is not intended to be exhaustive or to limit the invention to the precise form disclosed. Many modifications and variations are possible in light of the above teaching. For example, a variety of alternative calculations may be utilized according to the concepts of the present invention, as will be recognized by those skilled in the art. Such alternative calculations may include increasing the sale price of a vehicle or handling negative values for customer cash in order to “force” a lease to “fit” the customer's or the dealer's needs. It is intended that the scope of the invention be limited not by this detailed description, but rather by the claims appended hereto.

What is claimed is:

1. A method for selecting, from a plurality of lease programs, a lease program that requires the lowest monthly payment, the method comprising:
receiving a first input representing a target profit;
receiving a second input representing an amount of cash available for lease inception fees;
receiving financial information about a customer;
accessing a database stored in a computer system, the database comprising information about a plurality of lease programs; and
identifying, for each of the vehicles, the lease program requiring the identified lowest monthly payment.

2. The method of claim 1 wherein the identifying comprises:
calculating a monthly payment required by each of the plurality of lease programs for each of a plurality of vehicles, the monthly payment constrained by the target profit, the amount of cash available for lease inception fees and the financial information about the customer; and
for each of the vehicles, comparing the calculated monthly payments required by each of the plurality of lease programs and selecting the lowest monthly payment; and

3. A computer system configured to perform the method of claim 1, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

4. Computer readable storage media containing software which, when loaded on a computer and executed, enables the following steps to occur:
the computer receives a first input representing a target profit;
the computer receives a second input representing an amount of cash available for lease inception fees;
the computer receives financial information about a customer;
the computer accesses a lender database comprising information about a plurality of lease programs; and
the computer identifies, for each of the vehicles, the lease program requiring the identified lowest monthly payment.

5. The method of claim 1 wherein the receiving financial information about a customer comprises:
collecting information about the customer;
entering the collected information in a computer input device; and
transmitting the entered, collected information from the computer input device to a computer processing device, the computer processing device being configured to perform the remaining steps of the method of claim 1.

6. The method of claim 5 wherein the computer input device is in a location remote to the computer processing device.

7. The method of claim 6 wherein the collecting and entering are performed by a first user, and the computer processing device is operated by a second user.

8. A method for selecting, from a plurality of lease programs, a lease program for each of a plurality of customers, the method comprising:
collecting information about a first customer;
entering the collected information about the first customer in a first computer input device;
collecting information about a second customer;
entering the collected information about the second customer in a second computer input device;
transmitting the entered, collected information from the first and second computer input devices to a computer processing device, the computer processing device being configured to select, from a plurality of lease programs, a lease program according to a customer's information; and
causing the computer processing device to select a lease program for the first customer and a lease program for the second customer.

9. The method of claim 8 wherein the first computer input device and the second computer input device are located remote to each other.

10. The method of claim 8 wherein the first computer input device and the second computer input device are located remote to the computer processing device.

11. The method of claim 8 wherein the collecting and entering information about a first customer is performed by a first user and the causing the computer processing device to select a lease program for the first customer is performed by a second user.

12. The method of claim 11 wherein the collecting and entering information about a second customer is performed by a third user and the causing the computer processing device to select a lease program for the second customer is performed by the second user.

13. A method for selecting, from a plurality of lease programs, a lease program that generates the largest profit, the method comprising:
receiving a first input representing a target monthly payment amount;
receiving a second input representing an amount of cash available for lease inception fees;
receiving financial information about a customer;
accessing a database stored in a computer system, the database comprising information about a plurality of lease programs; and
identifying, for each of the vehicles, the lease program generating the highest profit.

14. The method of claim 13 wherein the identifying comprises:
calculating a profit generated by each of the plurality of lease programs for each of a plurality of vehicles, the profit constrained by the target monthly payment, the amount of cash available for lease inception fees and the financial information about the customer; and
for each of the vehicles, comparing the calculated profit generated by each of the plurality of lease programs and selecting the highest profit; and

15. A computer system configured to perform the methods of claim 13, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

16. Computer readable storage media containing software which, when loaded on a computer and executed, enables the following steps to occur:
the computer receives a first input representing a target monthly payment amount;
the computer receives a second input representing an amount of cash available for lease inception fees;
the computer receives financial information about a customer;
the computer accesses a lender database comprising information about a plurality of lease programs; and
the computer identifies, for each of the vehicles, the lease program generating the highest profit.

17. The method of claim 13 wherein the receiving financial information about a customer comprises:
collecting information about the customer;
storing the collected information in a first computer storage device; and
transmitting the stored, collected information from the first computer storage device to a central computer storage device, the central computer storage device being configured to perform the remaining steps of the method of claim 13.

18. A method for selecting, from a plurality of lease programs, a lease program that generates the largest profit for a particular monthly payment amount, the method comprising:
receiving an input representing an amount of cash available for lease inception fees;
receiving financial information about a customer;
accessing a database stored in a computer system, the database comprising information about a plurality of lease programs; and
identifying, for each of the vehicles, the lease program generating the highest profit for each of the monthly payment amounts.

19. The method of claim 18 wherein the identifying comprises:
calculating a set of profits generated by each of the plurality of lease programs for each of a plurality of vehicles, the set of profits comprising:
a profit calculated for each of a set of monthly payment amounts, each profit and each monthly payment amount constrained in the calculating by the amount of cash available for lease inception fees and the financial information about the customer;
the calculating comprising considering an upward adjustment in a sales price of the vehicle; and
for each of the vehicles, and each of the monthly payment amounts, comparing the calculated profit generated by each of the plurality of lease programs and selecting the highest profit.

20. A computer system configured to perform the methods of claim 18, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

21. Computer readable storage media containing software which, when loaded on a computer and executed, enables the following steps to occur:
the computer receives an input representing an amount of cash available for lease inception fees;
the computer receives financial information about a customer;
the computer accesses a lender database comprising information about a plurality of lease programs; and
the computer identifies, for each of the vehicles, the lease program generating the highest profit for each of the monthly payment amounts.

22. The method of claim 18 wherein the receiving financial information about a customer comprises:
collecting information about the customer;
storing the collected information in a first computer storage device; and
transmitting the stored, collected information from the first computer storage device to a central computer storage device, the central computer storage device being configured to perform the remaining steps of the method of claim 18.

23. A method for selecting, from a plurality of lease programs, a lease program capable of generating a specified paid reserve amount and calculating a money factor that causes the selected lease program must use to generate the specified paid reserve amount, the method including:
identifying a plurality of lease programs for which a customer qualifies according to customer information and a particular vehicle;
receiving an input representing a target paid reserve amount;
accessing a database stored in a computer system, the database comprising information about a plurality of lease programs;
calculating, for each of the plurality of lease programs, a minimum money factor that, when applied to the lease program, causes the lease program to generate the target paid reserve amount;
the calculating including considering an upward adjustment in a sales price of the vehicle; and
reporting which of the plurality of lease programs is capable of generating the target paid reserve amount and, for each of the capable lease programs, identifying the calculated minimum money factor that causes the lease program to generate the target paid reserve amount.

24. A computer system configured to perform the methods of claim 23, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

25. Computer readable storage media containing software which, when loaded on a computer and executed, enables the following steps to occur:
the computer identifies a plurality of lease programs for which a customer qualifies according to customer information and a particular vehicle;
the computer receives an input representing a target paid reserve amount;
the computer accesses a database comprising information about a plurality of lease programs;
the computer calculates, for each of the plurality of lease programs, a minimum money factor that, when applied to the lease program, causes the lease program to generate the target paid reserve amount;
the calculating including considering an upward adjustment in a sales price of the vehicle; and
the computer reports which of the plurality of lease programs is capable of generating the target paid reserve amount and, for each of the capable lease programs, identifying the calculated minimum money factor that causes the lease program to generate the target paid reserve amount.

26. The method of claim 23 wherein the receiving an input representing a target paid reserve amount comprises:
receiving an input representing a selection of a lease program from a plurality of lease programs; and
identifying the paid reserve amount that is generated by the selected lease program.

27. A computer system configured to perform the methods of claim 8, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

28. Computer readable storage media containing software which, when loaded on a computer and executed, enables the following steps to occur:
the computer identifies a plurality of lease programs for which a customer qualifies according to customer information and a particular vehicle;
the computer receives an input representing a selection of a lease program from a plurality of lease programs; and
the computer identifies the paid reserve amount that is generated by the selected lease program.
the computer accesses a database comprising information about a plurality of lease programs;
the computer calculates, for each of the plurality of lease programs, a minimum money factor that, when applied to the lease program, causes the lease program to generate the target paid reserve amount;
the calculating including considering an upward adjustment in a sales price of the vehicle; and
the computer reports which of the plurality of lease programs is capable of generating the target paid reserve amount and, for each of the capable lease programs, identifying the calculated minimum money factor that causes the lease program to generate the target paid reserve amount.

29. The method of claim 23 wherein the receiving an input representing a target paid reserve amount comprises:
receiving an input representing a selection of a lease program from a plurality of lease programs, the selected lease program having a first money factor and a first paid reserve amount;
receiving a second money factor different than the first money factor;
calculating a second paid reserve amount for the selected lease program according to the second money factor.

30. A computer system configured to perform the methods of claim 29, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

31. Computer readable storage media containing software which, when loaded on a computer and executed, enables the following steps to occur:
the computer identifies a plurality of lease programs for which a customer qualifies according to customer information and a particular vehicle;
the computer receives an input representing a selection of a lease program from a plurality of lease programs, the selected lease program having a first money factor and a first paid reserve amount;
the computer receives a second money factor different than the first money factor;
the computer calculates a second paid reserve amount for the selected lease program according to the second money factor.
the computer accesses a database comprising information about a plurality of lease programs;
the computer calculates, for each of the plurality of lease programs, a minimum money factor that, when applied to the lease program, causes the lease program to generate the target paid reserve amount;
the calculating including considering an upward adjustment in a sales price of the vehicle; and
the computer reports which of the plurality of lease programs is capable of generating the target paid reserve amount and, for each of the capable lease programs, identifying the calculated minimum money factor that causes the lease program to generate the target paid reserve amount.

32. A method for populating fields of a credit application, the method comprising:
receiving a credit report for a particular customer, the credit report containing data relevant to a plurality of financial aspects of the customer;
extracting the data from the credit report and associating the extracted data with a first set of pre-defined credit attributes;
identifying a second set of credit attributes within a credit application, the second set of credit attributes associated with data fields of the credit application;
matching each of the first set of pre-defined credit attributes to one of the second set of credit attributes; and
populating the fields of the credit application with the extracted data according to the matching of the first set of credit attributes to the second set of credit attributes.

33. A computer system configured to perform the methods of claim 32, the computer system comprising:
computer storage media containing software that is programmed according to the method;
a computer processor which, under control of the software, causes the method to be performed;
a peripheral input device for receiving data according to the method; and
a computer display device for reporting results of the performed method to a user of the computer system.

34. Computer readable storage media containing software which, when loaded on a computer and executed, enables the following steps to occur:
the computer receives a credit report for a particular customer, the credit report containing data relevant to a plurality of financial aspects of the customer;
the computer extracts the data from the credit report and associating the extracted data with a first set of pre-defined credit attributes;
the computer identifies a second set of credit attributes within a credit application, the second set of credit attributes associated with data fields of the credit application;
the computer matches each of the first set of pre-defined credit attributes to one of the second set of credit attributes; and
the computer populates the fields of the credit application with the extracted data according to the matching of the first set of credit attributes to the second set of credit attributes.
